(19) United States
(12) Patent Application Publication
(10) Pub. No.: US 2009/0012214 A1
(43) Pub. Date: Jan. 8, 2009

(54) Performance Grade Asphalt Composition and Method of Production Thereof

(75) Inventors: James Butler, League City, TX (US); Paul Buras, Houston, TX (US); William Lee, Humble, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/163,578

(22) Filed: Jun. 27, 2008

Related U.S. Application Data
(63) Continuation of application No. 11/005,525, filed on Dec. 6, 2004, now abandoned.
Application No. 11/005,525 is a continuation-in-part of application No. 11/001,361, filed on Dec. 1, 2004.

(51) Int. Cl. C08L 95/00; C09D 195/00

(52) U.S. Cl. 524/59; 106/284.3; 106/269

(57) ABSTRACT

An asphalt material having improved paving characteristics and processes for its preparation. An asphalt base material is heated in a mixing chamber to a temperature sufficient to melt the asphalt so that it can be stirred. A water-insoluble heavy metal soap is incorporated into the chamber in an amount effective to reduce the PAV-DSR temperature of the asphalt base material by an incremental amount of at least 1° C. Thereafter, the asphalt material is recovered from the mixing chamber to provide an asphalt product containing the heavy metal soap which exhibits a PAV-DSR temperature which is less than the PAV-DSR temperature for the corresponding base material without the addition of the heavy metal soap. The water-insoluble soap is a C₁₄-C₁₈ heavy metal soap such as a C₁₆-C₁₈ zinc- or calcium-based soap including zinc stearate, zinc oleate and zinc palmitate. The heavy metal soap is added to the mixing chamber in an amount within the range of 0.05-3.0 wt. % of the amount of asphalt based material in the mixing chamber. A thermoplastic polymer may be added to the asphalt based material to provide a polymer-modified asphalt blend. An asphalt paving composition comprising an asphalt base material and a water-insoluble heavy metal soap in an amount to provide a PAV-DSR temperature lower than the PAV-DSR temperature of the corresponding asphalt material without the addition of the heavy metal soaps.

### CROSS-REFERENCE TO RELATED APPLICATIONS

This application claims the benefit of U.S. patent application Ser. No. 11/005,525, filed Dec. 6, 2004 and U.S. patent application Ser. No. 11/001,361, filed Dec. 1, 2004.

### FIELD OF THE INVENTION

This invention relates to asphalt compositions and their preparation and more particularly, to asphalt compositions incorporating heavy metal soaps which impart desired rheological characteristics and physical parameters suitable for various applications in which asphalt formulations are employed.

### BACKGROUND OF THE INVENTION

Asphalt may be characterized as an organic cementitious material in which the predominant constituents are bitumens as they may occur in nature or as they may be produced as byproducts in petroleum refining operations. Asphalt can generally be characterized as a dark brown or black solid or highly viscous liquid, which incorporates a mixture of paraffinic and aromatic hydrocarbons as well as heterocyclic compounds containing Group 15 or 16 elements, such as nitrogen, oxygen or sulfur.

Asphalts have many industrial applications involving use as paving or road coating material, roofing materials, either as so-called composition shingles or in hot mix applications, and in various sealing applications. Perhaps the most widespread use of asphalt compositions is in road surfacing and paving applications. The asphalt may be used alone, such as where it is applied to the surface of an existing paving structure, or it may be used as an aggregate composition in which the asphaltic base material is mixed with an aggregate, typically in amount of 3-10 wt. % asphalt, with the remainder being the aggregate material. The asphalt material often is modified through the use of polymers to produce so-called polymer-modified asphalts. Polymer-modified asphalts or “PMA” function to provide improved characteristics as a paving material.

The use of asphalt compositions in preparing aggregate compositions of bitumen and rock useful as road paving material is complicated by at least three factors, each of which imposes a serious impediment to providing an acceptable product. First, the bitumen compositions must meet certain performance criteria or specifications in order to be considered useful for road paving. For example, to ensure acceptable performance, state and federal agencies issue specifications for various bitumen applications including specifications for use as road pavement. Performance standards and properties relating to asphalt cements are set forth in various standards of the American Society for Testing and Materials (ASTM) and the American Associate of State Highway and Transportation Officials (AASHTO). Current Federal Highway Administration specifications designate a bitumen (asphalt) product, for example, AC-20R (“R” meaning rubber modified), as meeting defined parameters relating to properties such as viscosity, toughness, tenacity and ductility. Each of these parameters define an important feature of the bitumen composition and compositions failing to meet one or more of these parameters may well render that composition unacceptable for use as road pavement material.

As noted previously, polymers can be added to asphalts to improve physical and mechanical performance properties. Polymer-modified asphalts can be used in the road construction/maintenance and roofing industries. Unmodified asphalts often do not retain sufficient elasticity in use and, also, exhibit a plasticity range that is too narrow for use in many modern applications such as road construction. The characteristics of road asphalts and the like can be greatly improved by incorporating into them an elastomeric-type polymer such as butyl, polybutadiene, polyisoprene or polyisobutene rubber, ethylene/vinyl acetate copolymer, polyacrylate, polymethacrylate, polychloroprene, polynorbornene, ethylene/propylene/diene (EPDM) terpolymer and advantageously a random or block copolymer of styrene and a conjugated diene, such as butadiene or isoprene. The modified asphalts thus obtained are referred to variously as bitumen/polymer binders or asphalt/polymer mixes. Modified asphalts and asphalt emulsions can be produced utilizing styrene/butadiene based polymers to provide raised softening points, increased viscoelasticity, enhanced force under strain, enhanced strain recovery, and improved low temperature strain characteristics.

The stability of polymer/bitumen compositions can be increased by the addition of cross-linking agents such as sulfur, which may be in the form of elemental sulfur. The sulfur can function to chemically couple the polymer and/or the bitumen through sulfide and/or polysulfide bonds. The addition of extraneous sulfur produces the improved stability, even though natural bitumens naturally contain varying amounts of native sulfur.

Asphaltic concrete, typically including asphalt- and aggregate, asphalt compositions for resurfacing asphaltic concrete, and similar asphalt compositions should exhibit a certain number of specific mechanical properties to enable their use in various fields of application, especially when the asphalts are used as binders for superficial coats (road surfacing), as asphalt emulsions, or in industrial applications. (The term “asphalt” is used herein interchangeably with “bitumen.” Asphaltic concrete is asphalt used as a binder with appropriate aggregate added, typically for use in roadways.) The use of asphalt or asphalt emulsion binders either in maintenance facings as a surface coat or as a very thin bituminous mix, or as a thicker structural layer of bituminous mix in asphaltic concrete, is enhanced if these binders possess the requisite properties such as desirable levels of elasticity and plasticity.

The grades and characteristics of asphalt paving products are addressed in a booklet entitled SUPERPAVE Series No. 1 (SP-1) “Performance Graded Asphalt Binder Specification and Testing,” 1998, published by the Asphalt Institute (Research Park Drive, P.O. Box 14052, Lexington, Ky. 40512-4052), the entire disclosure of which is incorporated by reference. Chapter 2 of the SUPERPAVE booklet provides an explanation of the test equipment, terms, and purposes involved. Rolling Thin Film Oven (RTFO) and Pressure Aging Vessel (PAV) studies are used to simulate binder aging (hardening) characteristics. Dynamic Shear Rheometers (DSR) are used to measure binder properties at high and intermediate temperatures. This is used to predict permanent deformation or rutting and fatigue cracking. Bending Beam Rheometers (BBR) are used to measure binder properties at low temperatures. These values predict thermal or low temperature cracking. The procedures for these experiments are also described in the above-referenced SUPERPAVE booklet.

Asphalt grading is given in accordance with accepted standards in the industry as discussed in the above-referenced Asphalt Institute booklet. For example, pages 62-65 of the booklet include Table 1 entitled “Performance Graded Asphalt Binder Specifications.” The asphalt compositions are given performance grades, for example, PG 64-22. The first number, 64, represents the average 7-day maximum pavement design temperature in ° C. The second number, −22, represents the minimum pavement design temperature in ° C. Other requirements of each grade are shown in the table. For example, the maximum value for the PAV-DSR test (° C.) for PG 64-22 is 25° C.

The PAV-DSR temperature and the BBR-M temperature are two important parameters of asphalt paving products. Industry custom uses the short form RTFO DSR to indicate the temperature at which a sample will show sufficient rutting resistance after rolling thin film oven (RTFO) aging (minimum rutting resistance as defined as a “G*/sin δ” over 2.20 kPA and measured by a dynamic shear rheometer (DSR)). Similarly, m-value is the short form to indicate the minimum temperature in degrees Centigrade at which a sample will exceed an m-value of 0.300 after 60 seconds of loading on the bending beam rheometer. The S value is the corresponding value in ° C. corresponding to the allowable deflection at 60 seconds. The operation of the bending beam rheometer to determine S values and M values is described in the SUPERPAVE Series I publication at pages 29-35.

### SUMMARY OF THE INVENTION

In accordance with the present invention, there is provided an asphalt material having improved paving characteristics and processes for preparation. In carrying out the present invention, an asphalt base material is heated in a mixing chamber to a temperature sufficient to melt the asphalt so that it can be stirred within the chamber. A water-insoluble heavy metal soap is incorporated into the chamber in an amount effective to reduce the PAV-DSR temperature of the asphalt base material by an incremental amount of at least 1° C. Thereafter, the asphalt material is recovered from the mixing chamber to provide an asphalt product containing the heavy metal soap. The asphalt product exhibits a PAV-DSR temperature which is less than the PAV-DSR temperature for the corresponding base material without the addition of the heavy metal soap. Preferably, the asphalt product exhibits a PAV-DSR value which is lower than the PAV-DSR temperature without the addition of the heavy metal soap by an incremental amount of at least 2° C. More preferably, the asphalt product exhibits a PAV-DSR value lower than the PAV-DSR temperature of the asphalt material without the addition of the heavy metal soap by an incremental amount of at least 5° C.

Preferably, the water-insoluble soap is a C₁₄-C₁₈ heavy metal soap or a C₁₄-C₁₈ calcium based soap. In a preferred embodiment of the invention, the water-insoluble soap is a C₁₆-C₁₈ zinc- or calcium-based soap and more preferably is selected from the group consisting of zinc stearate, zinc oleate, zinc palmitate and mixtures thereof. In a specific embodiment of the invention, the water-insoluble soap is added to the mixing chamber in an amount within the range of 0.05-3.0 wt. %, and more specifically 0.1-1.0 wt. %, of the amount of asphalt based material in the mixing chamber. In a further embodiment of the invention, prior to incorporation of the water-insoluble soap, a thermoplastic polymer is added to the asphalt based material to provide a polymer-modified asphalt blend within the chamber. Preferably, a cross-linking agent which is effective to cross-link the thermoplastic polymer, is also added to the mixing chamber.

In another aspect of the invention, there is provided an asphalt paving composition. The composition comprises an asphalt base material and a water-insoluble heavy metal soap in an amount to provide a PAV-DSR temperature lower than the PAV-DSR temperature of the corresponding asphalt material without the addition of the heavy metal soap. In a further aspect of the invention, the DSR temperature is less than the DSR temperature of the asphalt base material by a value which is less than the incremental amount of 2° C. Preferably, the paving composition incorporates an asphalt base material having a BBR-M temperature which varies from the BBR-M temperature of the asphalt base material without the incorporation of the heavy metal soap by a value which is less than the incremental amount. In a further aspect of the invention, the heavy metal soap is added in an amount effective to reduce the Brookfield viscosity of the asphalt material in the molten state by a factor of at least 5%.

Preferably, the asphalt paving composition comprises a thermoplastic polymer in an amount of no more than 15 wt. % of the total weight of the asphalt composition and also incorporates an inorganic aggregate material in admixture with the asphalt base material.

### DETAILED DESCRIPTION OF THE INVENTION

The present invention may be carried out in the preparation of bitumen or bitumen and polymer-based compositions having desired rheological properties which are incorporated into the asphaltic material through the use of water-insoluble heavy metal soaps. The asphalt based material of the present invention can be characterized in terms of its PAV-DSR, RTFO-DSR temperature and BBR-M temperatures as are well known to those skilled in the art.

As described in the aforementioned SUPERPAVE booklet, the PAV-DSR temperature is an intermediate temperature value which desirably is lowered to provide product improvement. The RTFO-DSR temperature is a higher temperature value which measures the characteristic of the asphalt base material in terms of a high temperature response limitation and the BBR-M temperature is a temperature which is much lower than the PAV-DSR temperature which measures a low temperature response limitation.

High and intermediate temperature performance grade (PG) tests both involve Dynamic Mechanical Analysis testing, specifically, DSR, to measure the asphalt's rheologic properties (AASHTO MP1). The high temperature test (designated as the DSR test) involves applying a torsional stress to a disk comprised of asphalt. A parameter, G*/sin(*), is obtained, where G* refers to the complex shear modulus and * is the phase angle offset between the applied stress and response of the material. G*/sin(*) provides a measure of the asphalt's stiffness at the upper range of its service temperature. This relates to the rutting resistance of road material containing the asphalt.

A particular PG designation specifies the temperature at which a certain minimum rheological parameter, as defined by SHRP test specifications, is reached under conditions for the DSR test. For example, an asphalt having a designation of PG64, indicates that a minimum G*/sin(*) of 1.0 kPA is reached at 64° C.; if the asphalt is associated with a lower G*/sin(*), then the asphalt fails the test at this temperature. Moreover, in order to meet a certain high temperature PG designation, analogous additional tests (AASHTO T240 herein designated as the RTFO-DSR test) must also be passed after aging the asphalt in an RTFO (Rolling Thin Film Oven)—AASHTO T240—Test Method for Effect of Heat and Air on a Moving Film of Asphalt.

The intermediate temperature PG test is conducted on asphalt already subjected to aging as part of the RTFO-DSR test, plus additional aging at a particular elevated temperature and pressure in a PAV (Pressure Aging Vessel)—AASHTO PPI Practice for Accelerated Aging of Asphalt Binder Using a Pressurized Aging Vessel, as designated by SHRP test methods. The test (AASHTO TP5 herein designated as the PAV-DSR test) is conducted at intermediate temperatures (e.g., between about 20° C. and 30° C.). The resulting parameter obtained, G*×sin(*), also provides a measure of stiffness. This, in turn, relates to the fatigue resistance of road materials containing the asphalt.

The low temperature PG test (designated herein as the BBR test), is conducted at temperatures ranging from about 0° C. to −34° C. (with extrapolation to lower temperature values), in order to assess the asphalt's low temperature rheologic properties (AASHTO TPI). The test involves applying a weight load to an asphalt sample formed into a beam at various temperatures. The deflection under load provides a means of determining creep stiffness (designated herein as the S-value) as well as the rate of change in creep stiffness (designated herein as the M-value). The creep stiffness (S) and creep rate (M-value) are calculated from the deflection under load measured during the test. Both the S-value and M-value are related to the low temperatures cracking resistance of road material containing the asphalt. The S and M values reported in the experimental work presented herein are the specification values in ° C. as contrasted with the measured values which are 10° C. above the specification values. For the various systems described below, the M value consistently provides a higher temperature than the S value, and thus the M value is the limiting factor indicating the lowest ambient temperature at which the asphalt can be used for road paving.

Analogous to the above-described DSR test, the PAV-DSR and BBR test results are expressed in terms of the maximum temperature at which the specified criteria is met.

Compatibility tests provide a measure of the degree of separability of materials comprising the asphalt (for example, Louisiana DOTD Test Method TP 326). The long-term compatibility between rubber and the other components of PMA, for example, is an important consideration when preparing road material. If rubber is not compatible with the other components of PMA, then the performance of road materials containing PMA is degraded. Compatibility is typically assessed by measuring the differences in softening point or other rheological property of the top and bottom layers of an asphalt sample held at a constant temperature under static conditions for a given period of time. Typically, an asphalt sample, such as PMA, is placed into an aluminum tube and then aged by heating the tube for 24 or 48 hours at a standardized temperature, for example, 162° C.

After the aging process, the tube is allowed to cool while being maintained in a vertical position, and then cut into three equal sections. Top and bottom sections from the tube are then compared for differences in their softening point using the Ring and Ball (R&B) test. The R&B test measures the deformation of an asphalt disk in response to an applied force at different temperatures. The softening point refers to the temperature at which a section deforms by more than 1″ (2.54 cm). If the difference in softening points between the top and bottom section is less than about 2° C., then the PMA is considered to have acceptable compatibility. In contrast, rubber that is incompatible with other components in PMA will tend to separate to the top section, as indicated by a softening point that is higher by an increment of at least 2° C. than the softening point of the lower section.

The present invention involves the incorporation of water-insoluble heavy metal soaps into asphalt compositions in order to improve their PG test scores as compared to the corresponding untreated asphalt. Certain types of asphalts are often unusable in road material because they fail the intermediate or low temperature PG tests. The traditional remedy is to add sufficient amounts of flux oil, such as Hydrolene, to produce an asphalt composition that passes these tests. The use of high flux oil contents, however, significantly raises the cost of producing asphalt suitable for use as road material. There is also the added risk that asphalt containing too much flux oil will fail the high temperature PG test. In the present invention, the addition of the heavy metal soaps improves the rheological properties of asphalt so as, for example, to provide an asphalt composition having a passing score for the PAV-DSR test at a lower temperature compared to the corresponding soap-free asphalt.

One embodiment of the present invention is directed to an asphalt composition comprising asphaltene, flux oil and a water-insoluble heavy metal soap. The heavy metal soaps employed in the present invention may comprise any heavy metal soap capable of improving the rheological properties, in particular fatigue resistance, of asphalt, as indicated by acceptable PAV-DSR test values at a lower temperature, as compared to the unmodified asphalt. Preferably, the soap is a C₁₄-C₁₈ heavy metal soap. In certain specific embodiments, the soap additive may comprise stearic acid salts, or metal stearates, such as calcium stearate, lithium stearate and more preferably, zinc stearate. The corresponding oleates and palmitates may be used. In addition, other fatty acids, fatty amines and fatty amide salts, and other soaps may be used in combination with a heavy metal soap.

The amount of soap added to the asphalt is determined by the extent to which the asphalt's rheologic properties are to be improved in order to be acceptable for use as road material. Preferably, the heavy metal soap, such as zinc stearate, comprises from about 0.05 to about 3.0%, and more preferably within the range of 0.1 to 1.0% by weight of the total weight of the asphalt composition.

An advantage of the use of the soap additive in accordance with the present invention is that they do not detrimentally affect the rheologic properties of the asphalt at high temperatures. Thus the inclusion of the soap modifier does not present a limitation in the use of the resulting asphalt composition as road material. The present invention, for example, may allow rubber-free asphalt with a lower flux oil content to be used as road material. The ability to provide a passing grade asphalt having a lower flux oil content represents a substantial improvement in the cost-efficient production of asphalt for road material use. Also, by circumventing the need to produce PMA, the above discussed compatibility problems associated with certain PMA's and additional processing steps, such as cross-linking, can be avoided.

In a further embodiment of the invention, the asphalt composition of the present invention may further include a polymer comprising a thermoplastic elastomer. Conventionally prepared PMA's have sufficient polymer contents, for example, thermoplastic elastomers such as rubber, having a content of about 3 to about 5% by weight, to provide adequate fatigue and crack resistance. Such conventional PMA's therefore are not typically limited for road material use because of failing intermediate or low temperature PG values. Rather, conventional PMA's are usually limited by failing either the high temperature PG or compatibility test. Inclusion of a heavy metal soap of the present invention, however, may allow a lower content of polymer to be used in PMA's, for example, rubber contents of less than about 2% by weight, thereby reducing compatibility problems or costs. At a certain low polymer content, for example, a rubber content of less than about 2% by weight, passing the intermediate and low temperature PG tests may become problematic. In these instances, adding a soap in accordance with the present invention may improve the rheologic properties of PMA's so as to allow their use as road material and reduces the costs of producing such PMA's.

While not limiting the scope of the present invention by theory, it is believed that asphalts comprise agglomerations of asphaltenes and resins having a molecular weight ranging from about 10,000 g/mol to about 200,000 g/mol. Resins are obtained as the middle cut in a three-stage solvent deasphalting process. The asphaltene is the heaviest cut from that process. The asphalt structure is thought to comprise agglomerations having a micelle structure, with a central core substantially comprising asphaltenes and a periphery substantially comprising resins. The polar portion of the resins associate with the asphaltene core, and the nonpolar portions of the resin form the outer surface of the agglomeration.

The heavy metal soaps are considered to improve the flow characteristics of the asphalt, as indicated by an improved intermediate PG test score. For example, the minimal acceptable test values for the PAV-DSR test is achieved at a lower test temperature for asphalt containing a heavy metal soap in accordance with the present invention. This, in turn, denotes an asphalt with improved fatigue resistance, as compared to the corresponding asphalt without the heavy metal soap present. Alternatively, an asphalt with a minimally acceptable test value and temperature can be prepared with less flux oil or polymer added to it.

One embodiment of the present invention provides a method of preparing an asphalt composition. The method comprises adding a heavy metal soap to crude asphalt while heating and stirring the asphalt at a speed, temperature and period sufficient to blend the heavy metal soap into the asphalt. In certain embodiments, the method may further include converting the asphalt composition into a PMA. The method includes adding a polymer and cross linking agents to the asphalt composition and heating and stirring the asphalt composition at a speed, temperature and period sufficient to mix the polymer into the asphalt composition and allow cross-linking of the polymer. Suitable polymers and cross-linking agents are well known to those skilled in the art. The polymer, for example, may comprise one or more thermoplastic elastomer, such as rubber. The cross-linking agent, for example, may comprise zinc oxide and 2-mercaptobenzothiazole. The polymer and cross-linking agent may be added to the asphalt composition after the addition of the heavy metal soap, or directly to the crude asphalt at the same time as or before the addition of the heavy metal soap.

In practicing the invention, after preparing an asphalt composition by adding the heavy metal soap to crude asphalt under conditions sufficient to blend the soap into the asphalt composition, the asphalt composition is shipped to a hot mix plant. The asphalt composition is added to aggregates to produce a hot mix asphalt road material. Similarly, the road material may further include the polymers or reduced flux oil contents as discussed above.

Another embodiment of the invention involves a paving composition comprising an asphalt composition and aggregates. The asphalt composition comprises asphaltene, flux oil and a heavy metal soap. In preferred embodiments, the soap comprises zinc stearate. The road paving material may further include the polymers or reduced flux oil contents as discussed above.

Experimental work respect the invention is set forth below. Two series of experiments were conducted to test the effect of adding zinc stearate on altering the SHRP tests values obtained for asphalt samples.

### Experiment 1

Four asphalt samples, having a performance grade of PG64-22, were tested as either: (1) asphalt as provided from an oil refinery (designated as “Asp”); (2) after the addition of zinc stearate (designated as “Asp+ZnStr”); (3) after the addition of rubber (designated as “PMA”); or (4) after the addition of both rubber and zinc stearate (designated as “PMA+ZnStr”). To prepare PMA, 4% by weight of a styrene butadiene block copolymer available from Atofina, Finaprene® 502, was added to Asp. The rubber asphalt mixture was then blended using a conventional high shear mixer operated at high (>2000) RPM with very close 2 mm clearance between the shearing plates. For the preparation of PMA+ZnStr, 0.5% by weight of zinc stearate was added immediately after the addition of rubber. The procedure for preparing Asp+ZnStr was the same as described herein, with the exceptions that rubber and cross-linking agents were not added to the Asp sample. Mixing was continued for 45 minutes at about 350° F. The mixture was then transferred to a conventional low shear mixer operated at less than 700 RPM with a propeller mixing head. In the preparation of PMA and PMA+ZnStr, cross-linking agents, comprising about 0.05% by weight zinc oxide and about 0.05% by weight 2-mercaptobenzothiazole and 0.1% sulfur were added to the mixtures, and blending was continued on the low shear mixer at approximately 250 rpm and 350° F. The mixtures were then aged by placing them in an oven maintained at 325° F. (163° C.) for 24 hours, before the SHRP tests were performed.

The results of SHRP tests are summarized in TABLE 1. In addition to the above-discussed SHRP tests, the Brookfield viscosity at 350° F. was measured for selected samples (ASTM 04402). As indicated in the TABLE, the presence of 0.5% zinc stearate reduced the PAV-DSR value for Asp+ZnStr by about 5.2° C., compared to Asp. Moreover, the test values obtained from the DSR and BBR tests were not detrimentally affected, compared to Asp. Nor did the addition of 0.5% zinc stearate detrimentally affect test values for PMA+ZnStr, compared to PMA. As shown by the data in Table 1, the addition of the newer 0.5% zinc stearate provided an amount effective to reduce the Brookfield viscosity of the polymer-modified asphalt from 304 cp to 280 cp, a reduction of about 8%.

TABLE 1

| Sample Test | Units | Asp | Asp + ZnStr | PMA | PMA + ZnStr |
|---|---|---|---|---|---|
| DSR | ° C. | 65.6 | 65.5 | 82.1 | 81.5 |
| RTFO-DSR | ° C. | 69.6 | 70.0 | 85.3 | 82.2 |
| PAV-DSR | ° C. | 17.1 | 11.9 | 19.0 | 16.8 |
| BBR (m-value) | ° C. | −16.9 | −15.7 | −16.0 | −17.4 |
| BBR (s-value) | ° C. | −20.2 | −20.0 | −21.7 | −24.2 |
| Compatibility | ° F. | nm | nm | 5.0 | 3.2 |
| Viscosity | cp | nm | 81 | 304 | 280 |

nm: not measured

### Experiment 2

Additional PAV-DSR tests were performed on an asphalt sample having a smaller amount of added zinc stearate. The crude asphalt sample was used as provided from the refinery (designated as “Asp2”), and had a grade of PG64-22. An asphalt sample containing 0.2% by weight zinc stearate (designated as “Asp2+ZnStr2”) was prepared by adding zinc stearate to Asp2, after preheating the asphalt sample to 350° F. The mixture was blended for 45 minutes at 350° F. in the above-mentioned low shear mixer. The PAV-DSR test value for Asp2+ZnStr2 was 21.5° C., while the corresponding value for Asp2 was 25° C.

Having described specific embodiments of the present invention, it will be understood that modifications thereof may be suggested to those skilled in the art, and it is intended to cover all such modifications as fall within the scope of the appended claims.

1. A method for preparing an asphalt composition comprising:
heating an asphalt base material in a mixing chamber to a temperature sufficient to melt the asphalt and allow stirring of the asphalt material within said chamber;
incorporating a water insoluble soap into said chamber in an amount effective to reduce the PAV-DSR temperature of said asphalt base material by an incremental amount of at least 1° C., wherein said water insoluble soap is a C₁₄-C₁₈ heavy metal or calcium based soap; and
recovering said asphalt material from said mixing chamber to provide an asphalt product containing said heavy metal soap which exhibits a PAV-DSR temperature which is less than the PAV-DSR temperature for the corresponding asphalt base material without the additional of said heavy metal soap.

2. (canceled)

3. The method of claim 1 wherein said water insoluble soap is a C₁₆-C₁₈ calcium- or zinc-based soap.

4. The method of claim 1 wherein said water insoluble soap is selected from the group consisting of zinc stearate, zinc oleate and zinc palmitate.

5. The method of claim 1 wherein said water insoluble soap is zinc oleate.

6. The method of claim 1 wherein said asphalt product exhibits a PAV-DSR value which is lower than the PAV-DSR temperature of said asphalt material without the addition of said water insoluble soap by an incremental amount of at least 2° C.

7. The method of claim 1 wherein said asphalt product exhibits a PAV-DSR value which is lower than the PAV-DSR temperature of said asphalt material without the additional of said water insoluble soap by an incremental amount of at least 3° C.

8. The method of claim 1 wherein said water insoluble soap is added to said chamber in an amount within the range of 0.05-3.0 wt. % of the amount of said asphalt base material in said chamber.

9. The method of claim 1 wherein said water insoluble soap is added to said chamber in an amount within the range of 0.1-1.0 wt. % of the amount of said asphalt base material in said chamber.

10. The method of claim 1 further comprising, prior to the incorporation of said water insoluble soap, adding a thermoplastic polymer to said chamber to provide a polymer-modified asphalt blend within said chamber.

11. The method of claim 9 further comprising adding a crosslinking agent effective to crosslink said thermoplastic polymer to said mixing chamber.

12. The method of claim 1 wherein said water insoluble soap is added to said chamber in an amount effective to reduce the Brookfield viscosity of said asphalt base material in said chamber by an amount of at least 5%.

13. An asphalt paving composition comprising an asphalt base material and a water insoluble soap in an amount effective to provide a PAV-DSR temperature which is lower than the PAV-DSR temperature of said asphalt base material without the additional of said water insoluble soap by an incremental amount of at least 1° C.

14. The composition of claim 11 wherein said asphalt base material has a DSR temperature which varies from the DSR temperature of said asphalt base material without the additional of said water insoluble soap by a value which is less than said incremental amount.

15. The asphalt paving composition of claim 11 wherein said asphalt base material exhibits a BBR-M temperature which varies from the BBR-M temperature of said asphalt base material without the addition of said water insoluble soap by a value which is less than said incremental amount.

16. The asphalt paving composition of claim 11 wherein said water insoluble heavy metal soap is present in an amount effective to provide a PAV-DSR temperature which is lower than the PAV-DSR temperature of said asphalt base material without the addition of said water insoluble soap by an incremental amount of at least 3° C.

17. The composition of claim 11 wherein said water insoluble soap is a C₁₄-C₁₈ heavy metal soap.

18. The composition of claim 11 wherein said water insoluble soap is a C₁₆-C₁₈ heavy metal soap.

19. The composition of claim 11 wherein said water insoluble soap is selected from the group consisting of zinc oleate, zinc palmitate and zinc stearate.

20. The composition of claim 11 wherein said asphaltic composition comprises a thermoplastic polymer in an amount of no more than 15 wt. % of the total weight of said asphalt composition.

21. The composition of claim 18 wherein said composition comprises an inorganic aggregate material in admixture with said asphalt base material.

22. The composition of claim 11 wherein said asphalt base material in the molten state has a Brookfield viscosity which is at least 5% less than the Brookfield viscosity of said asphalt base material without the addition of said water insoluble soap.
